(19) United States
(12) Patent Application Publication
(10) Pub. No.: US 2009/0125171 A1
(43) Pub. Date: May 14, 2009

(54) PROCESSOR SECURITY DIAGNOSTICS FOR HYBRID VEHICLE ELECTRIC MOTOR CONTROL SYSTEM

(75) Inventors: Stephen T. West, New Palestine, IN (US); Wei D. Wang, Troy, MI (US); Hanne Buur, Brighton, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., DETROIT, MI (US)

(21) Appl. No.: 12/240,259

(22) Filed: Sep. 29, 2008

Related U.S. Application Data
(60) Provisional application No. 60/986,373, filed on Nov. 8, 2007.

(51) Int. Cl. B60W 20/00; G01M 17/00

(52) U.S. Cl. 701/22; 701/31; 180/65.28

(57) ABSTRACT

A diagnostic system for a hybrid vehicle comprises a processor module and a motor control module. The processor module outputs a first seed value. The motor control module controls torque output by an electric motor of the hybrid vehicle and outputs a key value based on the first seed value. The processor module outputs a second seed value after receiving the key value, and the motor control module selectively diagnoses a fault in the processor module based on a comparison of the second seed value with the first seed value.

### CROSS-REFERENCE TO RELATED APPLICATIONS

This application claims the benefit of U.S. Provisional Application No. 60/986,373, filed on Nov. 8, 2007. The disclosure of the above application is incorporated herein by reference in its entirety.

### FIELD

The present disclosure relates to hybrid vehicles, and more particularly to processor security diagnostics for hybrid vehicles.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Referring now to FIG. 1, an electric hybrid vehicle 10 is shown. The electric hybrid vehicle 10 includes an engine assembly 12, a hybrid power assembly 14, a transmission 16, a drive axle 18, and a control module 20. The engine assembly 12 includes an internal combustion engine 22 that is in communication with an intake system 24, a fuel system 26, and an ignition system 28.

The intake system 24 includes an intake manifold 30, a throttle 32, and an electronic throttle control (ETC) 34. The ETC 34 controls the throttle 32 to control airflow into the engine 22. The fuel system 26 includes fuel injectors (not shown) to control a fuel flow into the engine 22. The ignition system 28 ignites an air/fuel mixture provided to the engine 22 by the intake system 24 and the fuel system 26.

The engine 22 is coupled to the transmission 16 via a coupling device 44. The coupling device 44 may include one or more clutches and/or a torque converter. The engine 22 generates torque to drive the transmission 16 and propel the electric hybrid vehicle 10. The transmission 16 transfers power from the engine 22 to an output shaft 46, which rotatably drives the drive axle 18.

The hybrid power assembly 14 includes one or more motor generator units. For example only, as shown in FIG. 1, the hybrid power assembly 14 includes two motor generator units: a first motor generator unit (MGU) 38 and a second MGU 40. The hybrid power assembly 14 also includes a power control device 41 and a rechargeable battery 42.

The first and second MGUs 38 and 40 operate independently and at any given time may each operate as either a motor or a generator. An MGU operating as a motor supplies power (e.g., torque), all or a portion of which may be used to drive the output shaft 46. An MGU operating as a generator converts mechanical power into electrical power.

For example only, the first MGU 38 may generate electrical power based on the output of the engine 22, and the second MGU 40 may generate electrical power based on the output shaft 46. Electrical power generated by one of the MGUs 38 and 40 may be used, for example, to power the other of the MGUs 38 and 40, to recharge the battery 42, and/or to power electrical components. While the MGUs 38 and 40 are shown as being located within the transmission 16, the MGUs 38 and 40 may be located in any suitable location.

The control module 20 is in communication with the fuel system 26, the ignition system 28, the ETC 34, the MGUs 38 and 40, the power control device 41, and the battery 42. The control module 20 is also in communication with an engine speed sensor 48 that measures an engine speed. For example, the engine speed may be based on the rotation of the crankshaft. The engine speed sensor 48 may be located within the engine 22 or at any suitable location, such as near the crankshaft.

The control module 20 controls operation of the engine 22 and the MGUs 38 and 40. The control module 20 also selectively controls recharging of the battery 42. The control module 20 controls recharging of the battery 42 and the operation of the MGUs 38 and 40 via the power control device 41. The power control device 41 controls power flow between the battery 42 and the MGUs 38 and 40. For example only, the power control device 41 may be an inverter and/or an IGBT (insulated gate bipolar transistor).

The control module 20 may include multiple processors for controlling respective operations of the electric hybrid vehicle 10. For example, the control module 20 may include a first processor for determining desired torque for the engine 22 and the MGUs 38 and 40 and a second processor for controlling torque of each of the MGUs 38 and 40.

### SUMMARY

A diagnostic system for a hybrid vehicle comprises a processor module and a motor control module. The processor module outputs a first seed value. The motor control module controls torque output by an electric motor of the hybrid vehicle and outputs a key value based on the first seed value. The processor module outputs a second seed value after receiving the key value, and the motor control module selectively diagnoses a fault in the processor module based on a comparison of the second seed value with the first seed value.

In other features, the motor control module selectively diagnoses the fault when the second seed value is equal to the first seed value.

In further features, the processor module sets the second seed value based on a comparison of the key value with an expected value.

In still further features, the processor module sets the second seed value based on the first seed value when the key value is one of greater than and less than the expected value.

In other features, the processor module sets the second seed value based on a third value when the key value is equal to the expected value, wherein the third value is one of greater than and less than the first seed value.

A diagnostic system for a hybrid vehicle comprises a processor module and a motor control module. The processor module outputs a first seed value. The motor control module controls torque output by an electric motor of the hybrid vehicle and outputs a key value after receiving the first seed value. The processor module generates a signal having one of a first state and a second state based on a comparison of the key value with an expected value.

In further features, the motor control module selectively diagnoses a fault in the processor module based on the key value and the state of the signal.

In still further features, the processor module generates the signal having the first state when the key value is equal to the expected value.

In other features, the motor control module selectively sets the key value based on an improper value that is not equal to the expected value and selectively diagnoses the fault when the processor module generates the signal having the first state.

In still other features, the motor control module sets the key value based on the expected value and selectively diagnoses the fault when the processor module generates the signal having the second state.

In further features, the processor module selectively diagnoses a fault in the motor control module based on the comparison.

In still further features, the processor module selectively diagnoses the fault when the key value is one of greater than and less than the expected value.

In other features, the processor module sets a second seed value based on the comparison and outputs the second seed value.

In further features, the processor module sets the second seed value based on the first seed value when the key value is one of greater than and less than the expected value.

A method for a hybrid vehicle comprises: transmitting a first seed value from a first module to a second module that controls torque output by an electric motor of the hybrid vehicle; transmitting a key value determined based on the first seed value from the second module to the first module; transmitting a second seed value from the first module to the second module after the first module receives the key value; and selectively diagnosing a fault in the first module using the second module based on a comparison of the second seed value with the first seed value.

In further features, the selectively diagnosing comprises selectively diagnosing the fault when the second seed value is equal to the first seed value.

In still further features, the method further comprises setting the second seed value based on a comparison of the key value with an expected value.

In other features, the setting the second seed value comprises setting the second seed value based on the first seed value when the key value is one of greater than and less than the expected value.

In still other features, the setting the second seed value comprises setting the second seed value based on a third value when the key value is equal to the expected value, wherein the third value is one of greater than and less than the first seed value.

A method for a hybrid vehicle comprises: transmitting a first seed value from a first module to a second module that controls torque output by an electric motor of the hybrid vehicle; transmitting a key value from the second module to the first module after the second module receives the first seed value; and generating a signal using the first module having one of a first state and a second state based on a comparison of the key value with an expected value.

In further features, the method further comprises selectively diagnosing a fault in the first module using the second module based on the key value and the state of the signal.

In other features, the generating the signal comprises generating the signal having the first state when the key value is equal to the expected value.

In further features, the method further comprises selectively setting the key value based on an improper value that is not equal to the expected value and selectively diagnosing the fault when the signal having the first state is generated.

In still further features, the method further comprises selectively setting the key value based on the expected value and selectively diagnosing the fault when the signal having the second state is generated.

In other features, the method further comprises selectively diagnosing a fault in the second module using the first module based on the comparison.

In further features, the selectively diagnosing the fault comprises selectively diagnosing the fault when the key value is one of greater than and less than the expected value.

In still further features, the method further comprises selectively setting a second seed value based on the comparison and transmitting the second seed value from the first module to the second module.

In other features, the selectively setting the second seed value comprises setting the second seed value based on the first seed value when the key value is one of greater than and less than the expected value.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an electric hybrid vehicle according to the prior art;

FIG. 2 is a functional block diagram of an exemplary control module that includes a hybrid control processor and a motor control processor according to the present disclosure;

FIG. 3 is a functional block diagram of an exemplary motor control system according to the present disclosure;

FIG. 4 is a functional block diagram of an exemplary motor control system of a vehicle having two electric motors according to the present disclosure; and

FIGS. 5-6 are flowcharts depicting exemplary methods performed by motor control systems according to the principles of the present disclosure.

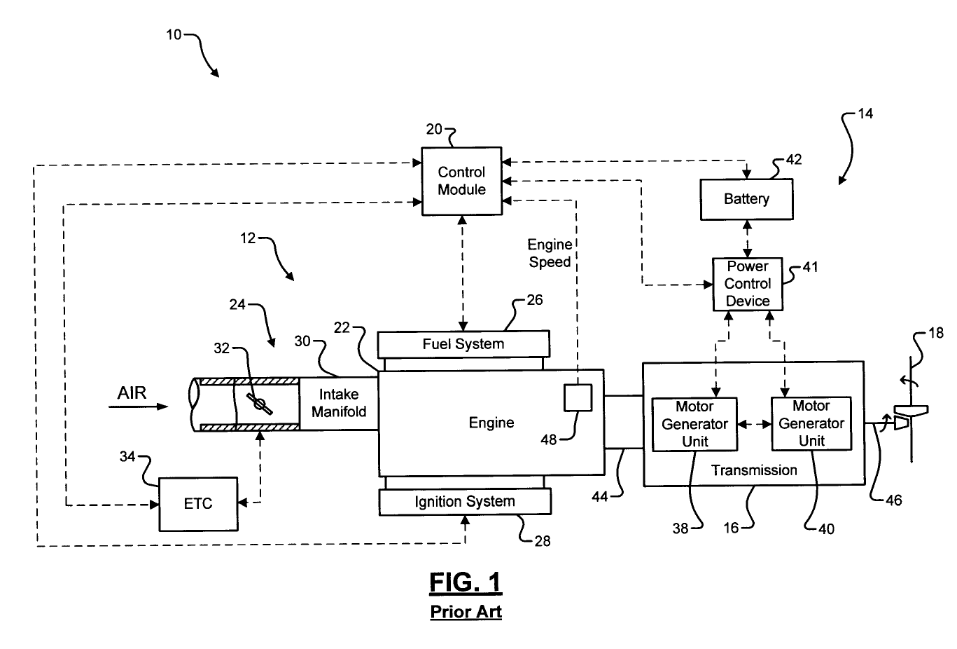

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

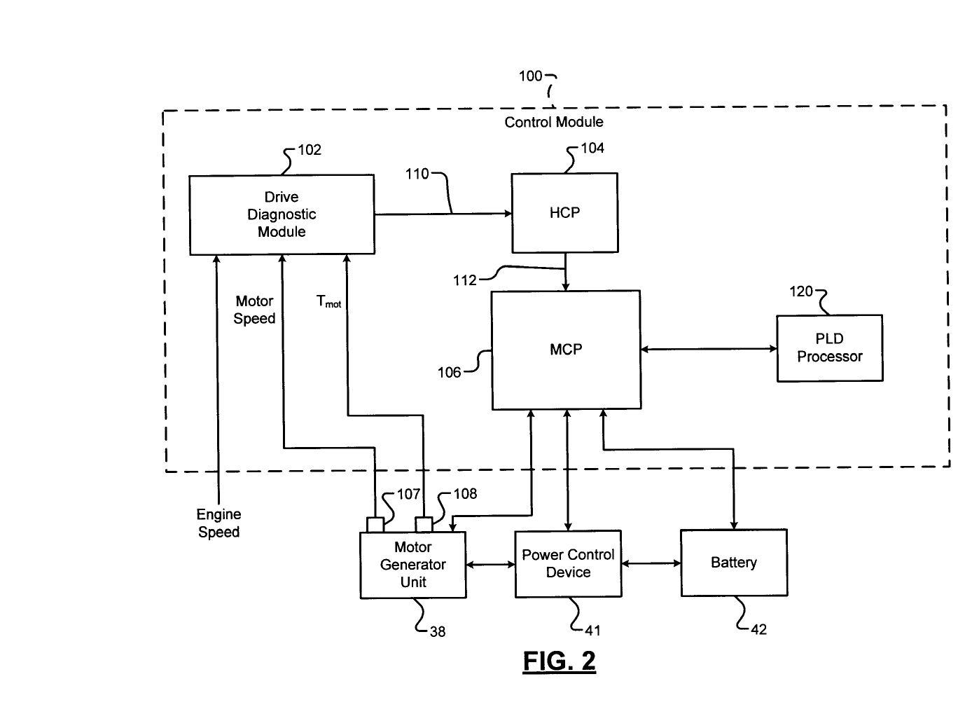

Referring now to FIG. 2, a functional block diagram of an exemplary control module 100 of an electric hybrid vehicle according to the present disclosure is presented. The control module 100 includes a drive diagnostic module 102, a hybrid control processor (HCP) 104, and a motor control processor (MCP) 106. The drive diagnostic module 102 receives various inputs including, but not limited to, engine speed, motor speed, and motor torque.

For example, the drive diagnostic module 102 receives the engine speed from the engine speed sensor 48. The drive diagnostic module 102 also receives a motor speed measured by a motor speed sensor 107 and a motor torque (Tₘₒₜ) measured by a motor torque sensor 108. The motor speed sensor 107 and the motor torque sensor 108 measure the speed and torque of the first MGU 38, respectively. As the electric hybrid vehicle 10 includes more than one MGU, the drive diagnostic module 102 may receive the motor speed and torque of more than one MGU. For example, the drive diagnostic module 102 may also receive the motor speed and torque of the second MGU 40.

The drive diagnostic module 102 generates various signals 110 based on the engine speed, the motor speed, and the motor torque. The HCP 104 receives the signals 110 from the drive diagnostic module 102. The HCP 104 determines a requested motor torque 112 for an MGU based on the received signals 110. While the HCP 104 is shown as determining the requested motor torque 112 for the first MGU 38, the HCP 104 may determine a requested motor torque for each of the MGUs 38 and 40.

The MCP 106 receives the requested motor torque 112 from the HCP 104 and controls the torque of the first MGU 38 based on the requested motor torque 112. For example, the MCP 106 may cause power to be supplied to the first MGU 38 in an amount that allows the first MGU 38 to produce the requested motor torque 112. In other words, the MCP 106 controls the torque of the first MGU 38 based on the requested motor torque 112. As such, it is desirable to ensure that the torque commanded by the MCP 106 accurately corresponds to the requested motor torque 112.

The control module 100 may include multiple layers of security/diagnostics to ensure accuracy and consistency between the HCP 104 and the MCP 106. For example, one layer of diagnostics may relate to diagnostics of basic components and subsystems such as voltage and current sensors, temperature sensors, and resolver performance diagnostics. Another layer of diagnostics may relate to an independent calculation of achieved motor torque. This independent calculation of the achieved motor torque may be implemented using separate memory locations for software, calibration variables, and static variables. Values used in the calculation may be verified (e.g., using checksum verification) between different execution loops.

Yet another layer of diagnostics may be implemented to prevent software execution and/or processor faults of the MCP 106. For example only, the control module 100 may include a processor such as a Programming Logic Device (PLD) processor 120. While the PLD processor 120 is shown as being located external to the MCP 106, the PLD processor 120 may be located in any suitable location.

The PLD processor 120 may be used to verify the MCP 106. Likewise, the MCP 106 may be used to verify the PLD processor 120. The PLD processor 120 and/or the MCP 106 may be verified via an information exchange. For example, the PLD processor 120 may send a seed value to the MCP 106. The MCP 106 determines a return key value based on the seed value and transmits the return key to the PLD processor 120.

The PLD processor 120 determines the functionality of the MCP 106 based on the return key (e.g., by comparing the return key to an expected key). If the return key does not match the expected key, the PLD processor 120 may implement remedial actions. For example, the PLD processor 120 may reset the MCP 106 and/or command the first MGU 38 to enter a secure shutdown mode. Similarly, the MCP 106 determines the functionality of the PLD processor 120 based on action the PLD processor 120 in response to the return key. If the PLD processor 120 does not respond as expected, the MCP 106 may implement remedial actions.

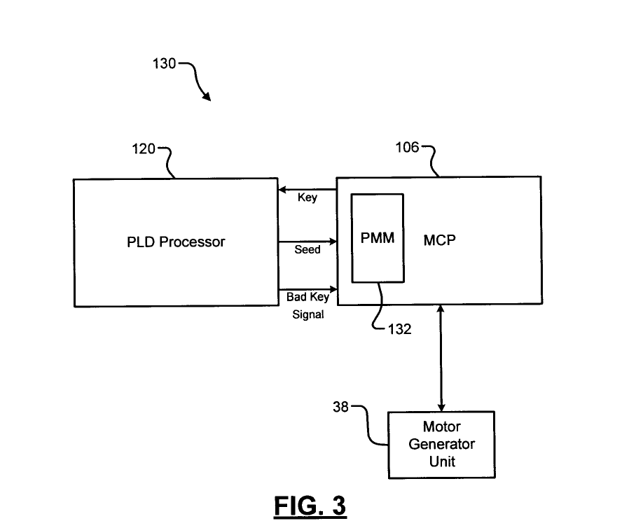

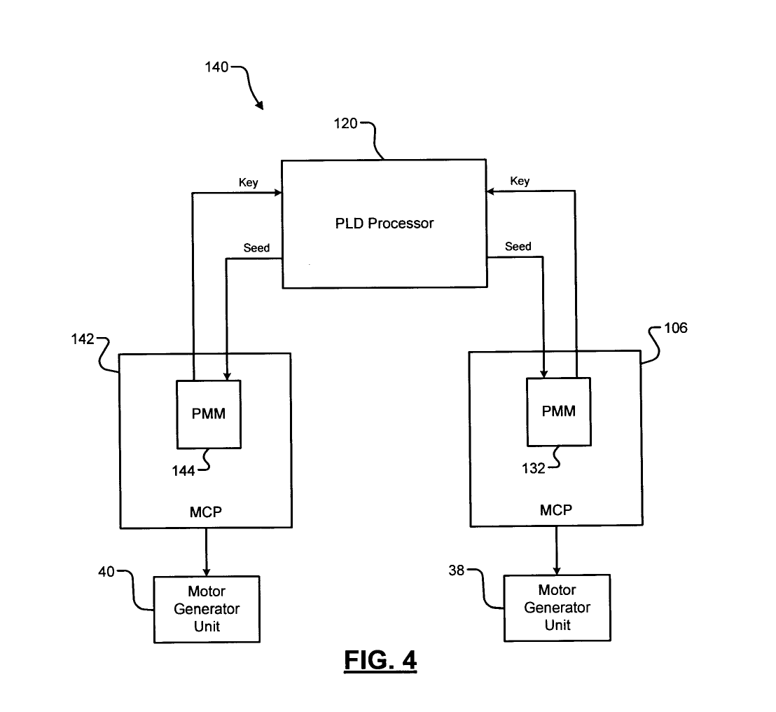

Referring now to FIG. 3, a functional block diagram of an exemplary motor control system 130 is presented. The motor control system 130 includes the MCP 106 that controls torque of the first MGU 38. The motor control system 130 may include one or more additional MCPs, such as those shown in FIG. 4. The MCP 106 may include one or more submodules, such as a processor monitoring module (PMM) 132. The PLD processor 120 communicates seed and return key information to and from the MCP 106 via the PMM 132.

Referring now to FIG. 4, a functional block diagram of an exemplary motor control system 140 is presented. The motor control system 140 includes the MCP 106 and a second MCP 142. The MCPs 106 and 142 control torque of the MGUs 38 and 40, respectively. Like the MCP 106, the second MCP 142 includes a processor monitoring module (PMM) 144. The second MCP 142 and the PMM 144 may function similarly or identically to the MCP 106 and the PMM 132. As such, while the principles of the present application will be discussed as they relate to the MCP 106 and the PMM 132, the principles of the present application are also applicable to the second MCP 142 and the PMM 144 and/or any other suitable MCP and PMM.

Referring again to FIG. 3, the PMM 132 monitors conditions of the PLD processor 120 and the MCP 106 and may provide warning and/or fault information when faults are detected. For example only, the PMM 132 may detect a PLD processor fault based on the seed/key exchange. In other words, the PMM 132 may log fault codes and/or trigger remedial action based on a faulty PLD processor 120. The PMM 132 may further determine proper program flow of motor torque monitoring.

The PLD processor 120 may also monitor the condition of the MCP 106 and initiate fault warnings/indications and/or initiate remedial action. For example, if the PLD processor 120 determines that the key received is incorrect, the PLD processor 120 may reset the MCP 106 and/or perform a motor shutdown procedure. Conversely, if the PMM 132 determines that the seed received from the PLD processor 120 is incorrect, the PMM 132 may perform a corresponding remedial action (e.g., log a corresponding fault code).

The PLD processor 120 generates the seeds based on a predetermined sequence. For example only, the predetermined sequence may be based on a Pseudo Random Binary Sequence (PRBS). The PMM 132 generates the return keys based on the seeds. The PMM 132 may generate the return keys, for example, according to a lookup table and/or a nonlinear mapping.

After receiving a return key, the PLD processor 120 determines whether the return key is correct. When the PLD processor 120 determines that the return key is correct, the PLD processor 120 sends another seed to the PMM 132. If, however, the PLD processor 120 determines that the PMM 132 returned an incorrect key, the PLD processor 120 may be expected to resend the same seed.

The PMM 132 then determines whether the PLD processor 120 sent an incorrect seed. For example, one of the MCP 106 and the PMM 132 may store the received seed in memory, such as a buffer (not shown). The PMM 132 reads the stored seed and determines whether the seed is an incorrect seed. For example, the PLD processor 120 may be expected to send different seeds between consecutive program loops. Accordingly, a received seed may be incorrect if it is the same as the stored seed.

The PMM 132 increments a fail count value (e.g., X of an X-of-Y counter) for each incorrect seed received. In other words, the PMM 132 increments the fail count value for each repeated transmission of the same seed. The PMM 132 may log a fault code and/or trigger an appropriate fault action if the fail count value reaches a limit (e.g., X>limit) within a predetermined period (e.g., Y of the X-of-Y counter). Each of the limit and the predetermined period may be set based on calibrated values.

The PMM 132 may also selectively intentionally send an incorrect return key to the PLD processor 120 to determine whether the PLD processor 120 is properly detecting incorrect return keys. The PLD processor 120 is expected to notify the PMM 132 when an incorrect key is received. For example, the PLD processor 120 may assert a signal, such as a bad key signal, on an input of the PMM 132 in response to an incorrect key. When the PMM 132 sends the correct key, the PLD processor 120 does not assert the signal.

When the PMM 132 determines that the PLD processor 120 did not respond appropriately to either a correct key or an incorrect key, the PMM 132 may increment a fail count value (e.g., X of an X-of-Y counter). The PMM 132 may log a fault code and/or trigger an appropriate fault action if the fail count value reaches a limit (e.g., X≧limit) within a predetermined period (e.g., Y of the X-of-Y counter). Each of the limit and the predetermined period may be set based on calibrated values.

When the PMM 132 is not functioning properly, the PMM 132 will return incorrect keys in response to received seeds. When the PMM 132 fails to return the correct key within a predetermined period, the PLD processor 120 may initiate remedial action. For example only, the PLD processor 120 may initiate a power-on reset of the MCP 106. The PLD processor 120 may also initiate a motor shutdown procedure. For example only, the motor shutdown procedure may include short circuiting or open circuiting all of the phases of the MGU 38. After the reset, the MCP 106 may initiate other remedial actions, including, but not limited to, logging a fault code. The HCP 104 may initiate other actions in response to the reset of the MCP 106, including, but not limited to, indicating a communication fault and/or initiating a global vehicle level shutdown.

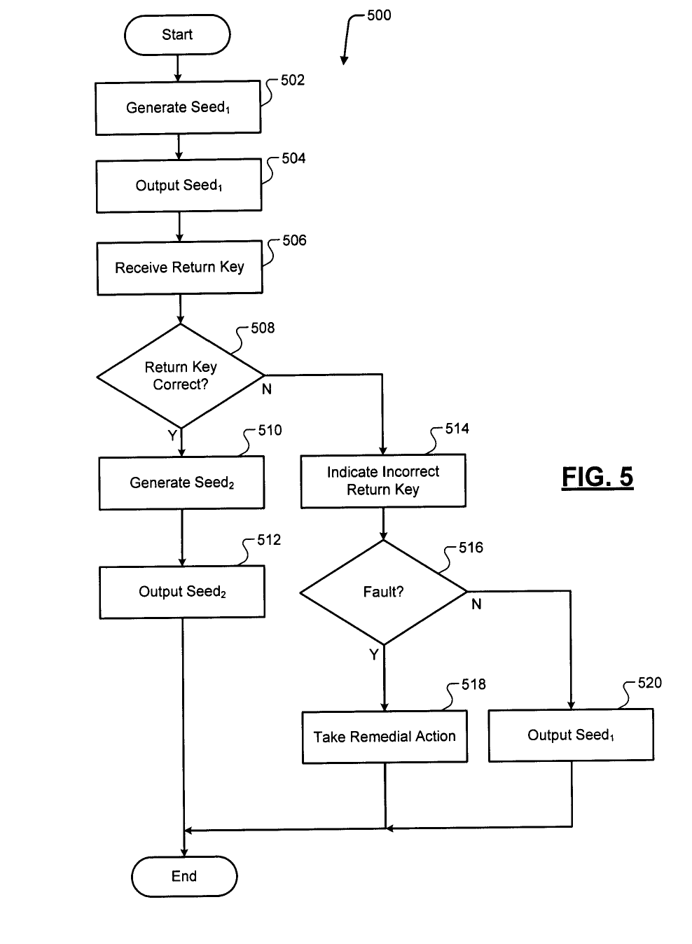

Referring now to FIG. 5, a flowchart depicting an exemplary method 500 performed by the PLD processor 120 is presented. The method 500 begins in step 502 where the method 500 generates a first seed (Seed₁). The first seed is output in step 504. The first seed is output to the PMM 132, which generates the return key.

The method 500 receives the return key in step 506 and determines whether the return key is correct in step 508. If the return key is correct, the method 500 continues to step 510; if the return key is incorrect, the method 500 transfers to step 514. The method 500 may determine whether the return key is correct, for example, based on a comparison with an expected return key.

In step 510, the method 500 generates a second seed (Seed₂). The method 500 outputs the second seed in step 512. In this manner, the method 500 generates the second seed when the PMM 132 returns the correct return key in response to the first seed. The method 500 then ends.

Referring back to step 514, the method 500 indicates that the return key is incorrect. In step 516, the method 500 determines whether a fault has occurred. If true, the method 500 continues to step 518; if false, the method 500 transfers to step 520. The method 500 may determine that a fault has occurred when, for example, the PMM 132 has returned an incorrect return key for at least a predetermined period of time. In step 518, the method 500 takes remedial action. The remedial action may include, for example, initiating a power-on reset of the MCP 106 and/or logging a fault code.

In step 520, the method 500 outputs the first seed. In this manner, the method 500 returns the first seed to the PMM 132 when the PMM 132 provides an incorrect return key in response to the first seed. The method 500 then ends. While the method 500 is shown as ending after steps 512, the method 500 may continue. For example, the method 500 may return to step 506 after step 512 or step 520 is performed.

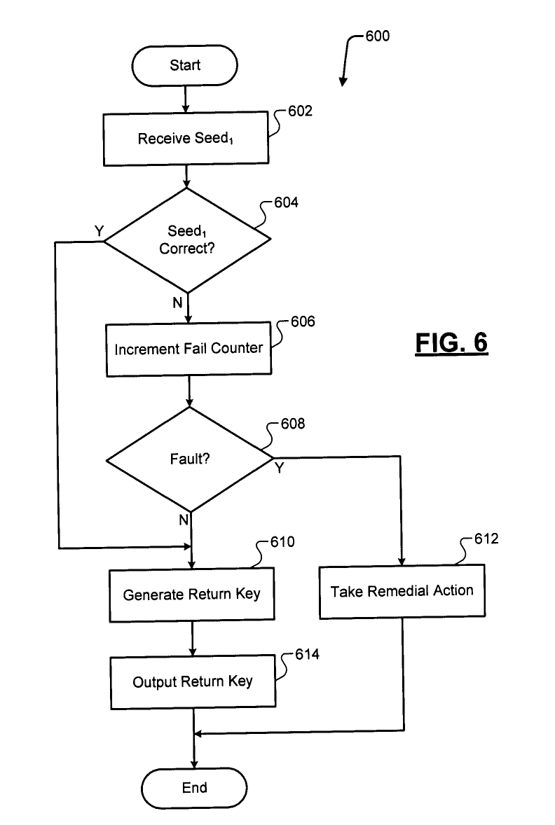

Referring now to FIG. 6, a flowchart depicting an exemplary method 600 performed by the PMM 132 is presented. The method 600 begins in step 602 where the method 600 receives the first seed (Seed₁). In step 604, the method 600 determines whether the first seed is correct. If the first seed is correct, the method 600 transfers to step 610; if the first seed is incorrect, the method 600 proceeds to step 606. The method 600 may determine that the first seed is incorrect when, for example, the first seed is the same the seed received before the first seed was received in step 602.

In other implementations, the method 600 may determine whether the PLD processor 120 has responded correctly in step 604. If the PLD processor 120 responded correctly, the method proceeds to step 610; if the PLD processor 120 responded incorrectly, the method 600 proceeds to step 606. The PLD processor 120 may respond incorrectly by, for example, failing to assert the bad key signal when the PMM 132 intentionally provided the PLD processor 120 with an incorrect return key.

The method 600 increments a fail counter in step 606 and determines whether a fault has occurred in step 608. If true, the method 600 proceeds to step 612; if false, the method 600 continues to step 610. For example only, the method 600 may determine that a fault has occurred when the fail counter reaches a predetermined value within a predetermined period of time. In step 612, the method 600 takes remedial action. The method 600 may take remedial action by, for example, initiating a power-on reset of the MCP 106 and/or logging a fault code. The method 600 generates the return key in step 610 and outputs the return key to the PLD processor 120 in step 614. The method 600 ends after step 612 or 614 is performed. While the method 600 is shown as ending after step 612 or 614, the method 600 may continue. For example, the method 600 may return to step 602 after step 614 is performed.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A diagnostic system for a hybrid vehicle, comprising:
a processor module that outputs a first seed value; and
a motor control module that controls torque output by an electric motor of said hybrid vehicle and that outputs a key value based on said first seed value,
wherein said processor module outputs a second seed value after receiving said key value, and
wherein said motor control module selectively diagnoses a fault in said processor module based on a comparison of said second seed value with said first seed value.

2. The diagnostic system of claim 1 wherein said motor control module selectively diagnoses said fault when said second seed value is equal to said first seed value.

3. The diagnostic system of claim 2 wherein said processor module sets said second seed value based on a comparison of said key value with an expected value.

4. The diagnostic system of claim 3 wherein said processor module sets said second seed value based on said first seed value when said key value is one of greater than and less than said expected value.

5. The diagnostic system of claim 3 wherein said processor module sets said second seed value based on a third value when said key value is equal to said expected value,
wherein said third value is one of greater than and less than said first seed value.

6. A diagnostic system for a hybrid vehicle, comprising:
a processor module that outputs a first seed value; and
a motor control module that controls torque output by an electric motor of said hybrid vehicle and that outputs a key value after receiving said first seed value,
wherein said processor module generates a signal having one of a first state and a second state based on a comparison of said key value with an expected value.

7. The diagnostic system of claim 6 wherein said motor control module selectively diagnoses a fault in said processor module based on said key value and said state of said signal.

8. The diagnostic system of claim 7 wherein said processor module generates said signal having said first state when said key value is equal to said expected value.

9. The diagnostic system of claim 8 wherein said motor control module selectively sets said key value based on an improper value that is not equal to said expected value and selectively diagnoses said fault when said processor module generates said signal having said first state.

10. The diagnostic system of claim 8 wherein said motor control module sets said key value based on said expected value and selectively diagnoses said fault when said processor module generates said signal having said second state.

11. The diagnostic system of claim 6 wherein said processor module selectively diagnoses a fault in said motor control module based on said comparison.

12. The diagnostic system of claim 11 wherein said processor module selectively diagnoses said fault when said key value is one of greater than and less than said expected value.

13. The diagnostic system of claim 11 wherein said processor module sets a second seed value based on said comparison and outputs said second seed value.

14. The diagnostic system of claim 13 wherein said processor module sets said second seed value based on said first seed value when said key value is one of greater than and less than said expected value.

15. A method for a hybrid vehicle, comprising:
transmitting a first seed value from a first module to a second module that controls torque output by an electric motor of said hybrid vehicle;
transmitting a key value determined based on said first seed value from said second module to said first module;
transmitting a second seed value from said first module to said second module after said first module receives said key value; and
selectively diagnosing a fault in said first module using said second module based on a comparison of said second seed value with said first seed value.

16. The method of claim 15 wherein said selectively diagnosing comprises selectively diagnosing said fault when said second seed value is equal to said first seed value.

17. The method of claim 16 further comprising setting said second seed value based on a comparison of said key value with an expected value.

18. The method of claim 17 wherein said setting said second seed value comprises setting said second seed value based on said first seed value when said key value is one of greater than and less than said expected value.

19. The method of claim 17 wherein said setting said second seed value comprises setting said second seed value based on a third value when said key value is equal to said expected value, wherein said third value is one of greater than and less than said first seed value.

20. A method for a hybrid vehicle, comprising:
transmitting a first seed value from a first module to a second module that controls torque output by an electric motor of said hybrid vehicle;
transmitting a key value from said second module to said first module after said second module receives said first seed value; and
generating a signal using said first module having one of a first state and a second state based on a comparison of said key value with an expected value.

21. The method of claim 20 further comprising selectively diagnosing a fault in said first module using said second module based on said key value and said state of said signal.

22. The method of claim 21 wherein said generating said signal comprises generating said signal having said first state when said key value is equal to said expected value.

23. The method of claim 22 further comprising:
selectively setting said key value based on an improper value that is not equal to said expected value; and
selectively diagnosing said fault when said signal having said first state is generated.

24. The method of claim 22 further comprising:
selectively setting said key value based on said expected value; and
selectively diagnosing said fault when said signal having said second state is generated.

25. The method of claim 20 further comprising selectively diagnosing a fault in said second module using said first module based on said comparison.

26. The method of claim 25 wherein said selectively diagnosing said fault comprises selectively diagnosing said fault when said key value is one of greater than and less than said expected value.

27. The method of claim 25 further comprising:
selectively setting a second seed value based on said comparison; and
transmitting said second seed value from said first module to said second module.

28. The method of claim 27 wherein said selectively setting said second seed value comprises setting said second seed value based on said first seed value when said key value is one of greater than and less than said expected value.
